(19) United States
(12) Patent Application Publication
(10) Pub. No.: US 2003/0051003 A1
(43) Pub. Date: Mar. 13, 2003

(54) Communication devices

(76) Inventors: Catherine Clark, British Columbia (CA); Sandra Beckstead, Long Itchington Southam (GB); Von Haselberg, Stoke Newington Fligh (GB); Marianne Jeffers, London (GB)

Correspondence Address: BANNER & WITCOFF, 1001 G STREET N W, SUITE 1100, WASHINGTON, DC, 20001, US

(21) Appl. No.: 10/168,301

(22) PCT Filed: Dec. 20, 2000
(86) PCT No.: PCT/GB00/04909

(30) Foreign Application Priority Data
Dec. 20, 1999 (GB) 9930034.5
Mar. 8, 2000 (GB) 0005602.8

(51) Int. Cl. G06F 15/16

(52) U.S. Cl. 709/218

(57) ABSTRACT

A communication device (1) operable to communicate with other communication devices in a network, one or more of the communication devices having means to receive identification data to authorize or identify a user as part of a closed community of users within the network, the closed community being defined by those communication devices within the network which have matching identification data.

This invention relates to a communication device and, more particularly, to a communication device for establishing communication between a closed group or community of users and to a communication device combining the use of a camera, an Internet connection, mobile communication technology, a LCD screen with stylus, and an address book.

Conventionally, communication devices such as mobile telephones, remote computers connected to the Internet and other similar devices enable communication between one person and another or between a group of people. Typically, only authorised users are permitted access to central information areas. For example, in the case of a web site, an authorised user may be required to give a password or the like in order to obtain access. In the case of a mobile telephone, an unauthorised user is simply not provided with the necessary mobile telephone number. Alternatively, no control may be exercised and free access would then be granted to all users.

It is difficult for untrained individuals to manage and control communication with and access to areas of, for example, the Internet, especially where access to such communication or information is only provided to authorised individuals. Typically, the management and control of such access would be carried out by an expert in the technical field, such as an information technology professional.

It is an object of the present invention to seek to provide a communication device and a method of providing access to communication within a closed group of users using communication devices which does not suffer from the above-mentioned problems and which can be readily operated by an untrained individual.

Accordingly, one aspect of the present invention provides a communication device operable to communicate with other communication devices in a network, one or more of the communication devices having means to receive identification data to authorise or identify a user as part of a closed community of users within the network, the closed community being defined by those communication devices within the network which have matching identification data.

Preferably, the identification data is stored in a physical element for attachment to or incorporation in a communication device.

Advantageously, the identification data is stored in the communication device and is made accessible by a physical element for attachment to or incorporation in a communication device.

Conveniently, the physical element is a plug which is insertable in a socket of a communication device.

Preferably, the physical element is provided with a graphical representation indicative of a closed community defined by the identification data.

Advantageously, the identification data comprises an authorisation or identification code, a password, a telephone number, an e-mail address, an IP address, or a URL.

Conveniently, the identification data is graphically represented in an online environment and is obtainable therefrom for distribution to users to establish a closed community for communication between users provided with the same identification data.

Preferably, matching means are provided to enable communication between communication devices if identification data held by one communication device matches identification data held by another communication device and to prevent communication between communication devices if identification data held by one communication device does not match identification data held by another communication device.

Conveniently, the communication device is a mobile communication device.

Advantageously, the communication device is a personal computer.

Preferably, the communication device further comprises: a camera operable to capture digital images and at least one display screen to display the resultant images.

Conveniently, the communication device further comprises a memory incorporating an address database, the address database containing a plurality of address records comprising contact information.

Advantageously, a captured image is associated with an address record in the address database.

Another aspect of the present invention provides a communication device operable to communicate with other communication devices in a network, the communication device comprising: a camera operable to capture digital images; at least one display screen to display the resultant images; a memory incorporating an address database, the address database containing a plurality of address records comprising contact information, wherein a captured image is associated with an address record in the address database.

A further aspect of the present invention provides a communication device operable to communicate with other communication devices in a network, the communication device comprising: mobile communication means having a network connection; at least one display screen to display the symbols; a memory incorporating an address database, the address database containing a plurality of address records comprising contact information, wherein a symbol downloaded from the network is associated with an address record in the address database.

Advantageously, each symbol has an associated communicator linking code operable to link the device having the communicator linking code resident therein with one or more other devices also having the communicator linking code resident therein.

Conveniently, the captured images or symbols are displayed and a selector is provided to select one of the displayed captured images or symbols to enable communication with the or each contact identified by the address record associated with a selected captured image or symbol.

Preferably, a further display is provided and the captured images or symbols are displayed thereon.

Advantageously, a further database is provided comprising a transaction database of items which are intended to be bought, collected, hired, swapped, exchanged or otherwise transacted.

Conveniently, each record held on the transaction database is associated with an item and includes an image of the item captured using the camera of the communication device.

Another aspect of the present invention provides a network of communication devices, one or more of the communication devices having means to receive identification data to authorise or identify a user as part of a closed community of users within the network, the closed community being defined by those communication devices within the network which have matching identification data.

A further aspect of the present invention provides a method of establishing a closed community within a communications network comprising the steps of: providing a network of communication devices operable to communicate with one another; distributing identification data to selected ones of communication devices within the network; enabling communication between communication devices having matching identification data; and preventing communication between communication devices not having matching identification data.

Preferably, a server in the network is advised of a new closed community and identification data is distributed to the members of the closed community by the server.

Conveniently, identification data is distributed to selected ones of communication devices within the network by the following steps: one of the communication devices sends to the server the identification data and details of the intended members of the closed community; the server stores the identification data and details of the intended members of the closed community; and each intended member of the closed community downloads the identification data from the server.

Advantageously, the server requests each intended member of the closed community to collect a message and, upon collection of said message, the intended member of the closed community downloads the identification code to enable communication between communication devices having matching identification data.

Preferably, communication between communication devices having matching identification data takes place via a network node specified by the identification data.

Advantageously, the network node is a website, forum or chat site.

A further aspect of the present invention provides a network consisting of at least one server having a database resident thereon and accessible by a plurality of mobile communication devices, each communication device having: a unique identifier; a camera for capturing images; a contact database; and a display, wherein the database resident on the server carries a plurality of records, each record comprising at least the following information: a captured image of an item; and the unique identifier of a communication device associated with the item.

Preferably, each record on the database resident on the server also includes a category identifier to identify which category of item the item falls within.

Advantageously, each communication device also includes a group database comprising a plurality of records each of which specifies a group member identified by a captured image of the group member and the unique identifier of that group member's communication device.

Conveniently, the group members are defined by those group members having a communication device with identification data stored in a physical element for attachment to or incorporation in a communication device.

Alternatively, the group members are defined by those group members having a communication device with identification data obtained from an online environment for distribution to users to establish a closed community for communication between users provided with the same identification data.

Advantageously, a communication device has access to only those records on the database resident on the server which are associated with a group member included in the group database of that communication device.

Another aspect of the present invention provides a communication device for use in a network consisting of at least one server having a database resident thereon and accessible by a plurality of mobile communication devices, the communication device comprising: a unique identifier; a camera for capturing images; a display; and a group database comprising a plurality of records each of which includes the identification of a group member by a captured image of the group member and a unique identifier of that group member's communication device, wherein the database resident on the server carries a plurality of records, each record comprising at least the following information: a captured image of an item; and the unique identifier of a communication device associated with the item, the communication device having access to only those records on the database resident on the server which are associated with a group member included in the group database of that communication device.

A further aspect of the present invention provides a method of establishing and accessing a remote database comprising the steps of: providing a mobile communication device having: a unique identifier; a camera for capturing images; a display; and a group database comprising a plurality of records identifying group members; providing a server having a database resident thereon storing a plurality of records; capturing an image of an item; sending the captured image and the unique identifier to the server for inclusion on the server database as a new record; and allowing access by a communication device to records on the server database.

Typically, portable communication devices are of necessity small objects and can display only limited amounts of information at one time. Whilst text communicates information, it does require a relatively large amount of screen space to achieve this aim. Accordingly, another object of the present invention is to seek to provide a more convenient means, for a portable communication device, for conveying information to a user of a portable communication device and for allowing access to the features and functions of the portable communication device, most particularly, an address book thereof.

In order that the present invention may be more readily understood, embodiments thereof will now be described, by way of example, with reference to the accompanying drawings, in which:

FIG. 1 is a schematic view of a portion of the rear of a mobile communication device embodying the present invention;

FIG. 2 is a side view of a plug for use with the mobile communication device of FIG. 1;

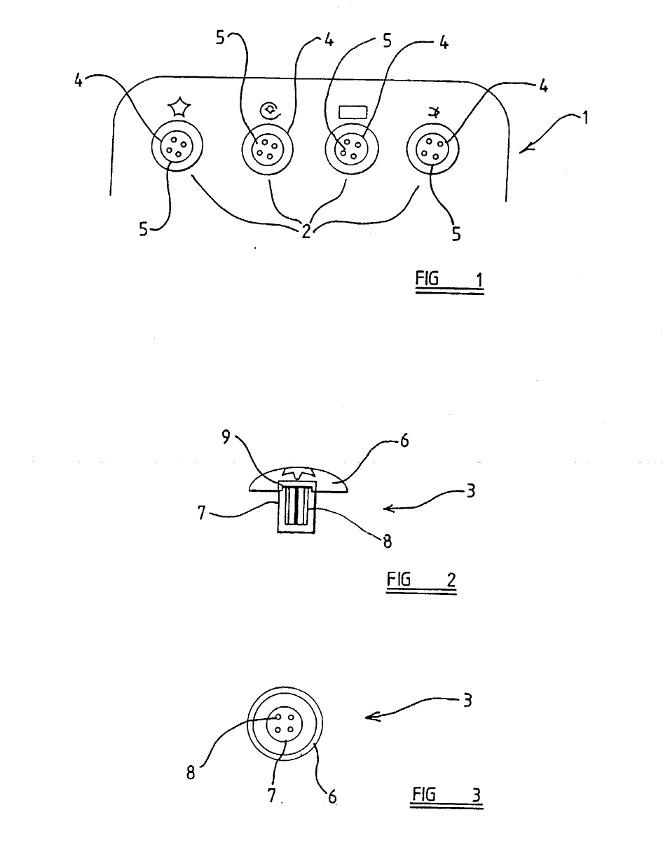

FIG. 3 is an end view of the plug of FIG. 1; and

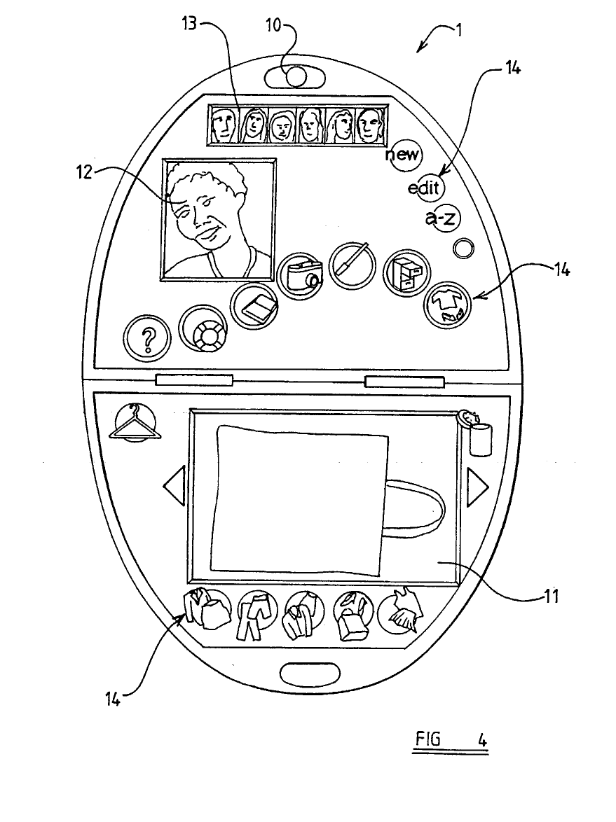

FIG. 4 is a front view of a mobile communication device embodying one aspect of the present invention.

Referring now to FIG. 1, a mobile communication device 1 embodying the present invention comprises a receiver, a transmitter, and a processor. Under control of the processor, the communication device 1 is operable to establish communication with other similar mobile communication devices in a conventional manner. For example, if the mobile communication device is a mobile telephone, then the telephone can make and receive calls to other mobile telephones in a conventional manner.

As can be seen in FIG. 1, the mobile communication device 1 has a number of sockets 2 which are each adapted to receive plugs 3. Each socket 2 comprises a central bore 4 housing a plurality of electrical terminals 5.

Referring now to FIGS. 2 and 3, a plug 3 comprises a rounded head 6 having a cylindrical sleeve 7 projecting therefrom which encloses one or more electrical terminals 8. The electrical terminals 8 within the sleeve 7 are connected to an electronic device 9 also housed within the sleeve 7 or within the rounded head 6. The electronic device 9 is in the form of an EPROM, a hard wired circuit or some other non-volatile means of storing data.

Preferably, the head 6 of the plug 3 is provided with a distinctive graphical representation or icon.

When the plug 3 is inserted in a socket 2 on the mobile communication device 1, the electrical terminals 5 in the mobile communication device co-operate with the electrical terminals 8 in the plug 3 and electrical connection is establish between the plug and the mobile communication device. Thus, the electronic device 9 within the plug 3 and, more particularly, the data held on that electronic device 9 is interrogated by the processor of the mobile communication device 1.

The data held on the electronic device 9 can be in a number of forms and can comprise, for example, an authorisation or identification code, a password, a telephone number, an e-mail address, an IP address, or a URL. Other identifiers may also be used.

In operation, the mobile communication device 1 is operable in a conventional manner to enable communication by the user of the mobile communication device with users of other communication devices. However, when the plug 3 is inserted in the socket 2 on the mobile communication device 1 and the processor has interrogated the plug to obtain the data stored on the plug, the mobile communication device is then operable in a different mode to the conventional. The new mode enables the mobile communication device to establish a closed community of communication devices which can communicate with one another and which exclude, from that community, non-authorised users.

Taking the present example in which the communication device is a mobile telephone, or at least includes features conventionally found on a mobile telephone, the mobile communication device 1 establishes the closed community in the following manner. A number of mobile communication devices are provided with identical plugs. The plugs may be issued between friends or by a service provider or the like to a limited number of individuals. When those individuals insert the plugs in the sockets on their mobile communication devices, each of the processors in those mobile communication devices recognises the inserted plug by the data stored therein. The principle is that any user having a communication device incorporating a plug having a particular identification code associated therewith is able to communicate, within a closed network, with other users having communication devices incorporating a plug having a matching identification code. The closed network or community prevents other users of communication devices from entering into communication with closed community users unless those users have been authorised by being provided with a plug having a matching identification code.

There are many ways of implementing the above principle of operation. One example, in the field of mobile telephones, is to allow calls to be established in a conventional manner but to include as part of the data packets sent between the mobile telephones, the data comprising the identification data held within the plug. Upon reception of a data packet from a mobile telephone, the mobile telephone checks the data packet to see if the identification data is attached and, if that identification data matches the data held in one of the plugs on that mobile telephone, then communication is enabled. However, if the identification data does not match the data held in the plugs on the mobile telephone, then the connection is dropped and communication between the two mobile telephones is prevented. Thus, only those mobile telephones having identical plugs are able to communicate with one another in the closed community. Conference calling is enabled to allow more than two users within the same closed community to chat to one another.

It should be appreciated that the scope of the present invention is not limited to verbal communication on mobile telephones but extends to text messaging, communication of digital images as well as to the Internet, web site or e-mail access where the same or other particular methods of operation can be used to achieve communication within a closed community using the principles described above.

The physical plugs are each preferably provided with a distinctive symbol or icon indicative of a particular closed community to which that plug provides access. It is also envisaged that a combination of two or more plugs may be required to allow access to particular closed community sites or to various levels or area is within a particular community or site.

The use of a physical plug connectable to a communication device is particularly advantageous to create and manage a closed community within which communication is enabled since no training is required and a constant visual indication is provided by the plug indicative of those close communities to which that particular user is a party.

The connection mechanism between the plug and the socket on the mobile communication device can be in the form of a screw, a clip, or a popper with a spring loaded mechanism. However, in each case, it is essential that good electrical contact is made between the plug 3 and the communication device 1. The shapes of the bore 4 and sleeve 7 are not of prime importance but do need to co-operate with one another, preferably with a push fit.

It is envisaged that communication devices embodying the present invention and incorporating the physical plugs described above would also be provided with a display screen. When a physical plug 3 is correctly inserted in the communication device 1, then the icon ornamenting the plug head 6 would preferably be displayed on the screen to indicate that the closed community represented thereby is available for communication. The icon would also preferably be automatically added to a menu list to facilitate communication within the indicated closed community.

It is also envisaged that the plugs can be used to provide the communication device with additional functional features in addition to being able to define a closed community.

As well as defining a closed community, the plugs can be provided with a credit of a monetary value so as to allow a user to be charged when accessing specified areas which are “unlocked” by the plug. This enables the user to make purchases over the Internet. The use of a plug having a monetary credit is not limited to only those areas of the Internet or whatever network which are unlocked by the plug. Further, the plug can have a “pay as you go” facility so that communication within the group is charged to the plug when communicating within the group.

A particularly beneficial application of this technology is the distribution of the plugs by sponsors, local merchants or other organisations as a means for disseminating promotional material and offers. For example, retailers, theatres, cinemas, music bands, concert promoters and the like could distribute plugs to direct a user to a particular website and gain access to promotional offers, information such as viewing upcoming sales or catalogues of merchandise, games, competitions, performance details and bookings on that website. The plugs could be distributed without charge, at a cost or provided as a loyalty bonus. Plugs can also be distributed by mail or courier to users and can be encoded with the location of, for example, the nearest retailer based on the postal code of the addressee. Plugs can also be distributed with printed material such as with a magazine. In this case the plug could contain an address for a web site related to the magazine or advertisers within the magazine.

The communication device is preferably a mobile communication device but can also be a remote computer hard wired into a network or connectable to the Internet by suitable telecommunication means. Rather than using the mobile cellular telephone networks, the communication devices could also be embodied to have local area wireless network communication between one another using, for example, optical or infra-red data transfer techniques.

Other embodiments of the present invention are also envisaged which do not use physical devices and which find application on the Internet or in other online environments. In such embodiments, the plugs are shown graphically on a web site or the like as icons and can be acquired by individuals to allow communication in a closed community by other users who have also acquired the same plug. The data stored by the plugs is preferably representative of a particular one or group of web sites or e-mail addresses within which or between which a close community can be established. Preferably, a user selects a plug represented by a graphical icon from a web site and downloads the plug. Once the plug has been downloaded, the user can then distribute the plug or copies thereof to other users that they would like to include within a closed community. When a user utilises their Internet browser and clicks on the downloaded icon, the user is automatically connected to the web site specified by the identification data stored in the “virtual” plug. Alternatively, if the icon contained in the identification data relates to an e-mail address, then the user is prompted to provide a message for sending to the designated e-mail address. Thus, user access is allowed in shared areas by distributing plugs to selected individuals in an online environment.

Another aspect of the present invention is now described. As depicted in FIG. 4, a communication device 1 embodying the present invention comprises: a processor including or having access to mobile communication technology and an Internet connection (not shown); a camera 10; at least one display screen 11, 12, 13, preferably LCD; a stylus (not shown); and a memory (not shown) incorporating an address book or database. The communication device also includes a keyboard or at least a form of key pad 14.

The mobile communication technology and the Internet connection enable Internet access for the device, preferably using a Wireless Application Protocol (WAP).

The camera 10 is operable to capture digital images and the screen 11 can be used to display and, with the aid of the stylus, manipulate the resultant images and any other stored or downloaded images. The address book contains a plurality of address records comprising contact information for individuals or groups of individuals and is operable to interface with the mobile communication technology and the Internet connection to establish communication with selected individuals, groups or a particular web site. Each address record includes the identity of the addressee and a record specifying how that addressee can be contacted. The record is preferably an IP address or a communication device address code but may comprise other or additional information such as a telephone number. Captured images are preferably stored in the address book/database, or are at least accessible therefrom. The stylus and key pad 14 provide means by which a user can interface with the communication device. The processor is operable to drive and control the other devices.

The device also incorporates a physical plug, as described above, which can be inserted or removed from the communication device. When the plug is inserted in the device, a symbol appears on the screen and supplies an access code which is used to facilitate, or by its removal stop, communication to either an Internet site or a single person or group of people.

In operation, images captured by the camera in the communication device are saved preferably directly into the address book/database or a database accessible by the address book.

The user may thus enter a captured image into the address book to create a visual symbol that can be related to a particular address record. To enter the image into the address book, the user takes a digital photograph by pointing the camera at the required person or object and pressing a key which causes the photo to be captured. The captured image appears on the screen of the communication device. The user chooses to accept the image and confirms this by indicating with the stylus or pressing a key to enter the photo into the address book or other areas. The communication device then closes the camera program and opens the address book program and requests the user to associate the captured image with an address record or to create a new address record incorporating the captured image.

To associate a captured image with an address record, the user must enter the name of an existing record in a Name field of the address book in order to bring up that existing record. The captured image can then be associated with that particular entry and added to the address database. If a new entry is to be created, then a new name is entered in the Name field to create a new record associated with the captured image.

The user can include further useful information to the record associated with the captured image, such as an Internet address, a communication device address, a birthday and other details.

Once the captured image is associated with an address record, the captured image becomes a symbol directly associated with the stored communication device address code or IP address. The captured image can be attached to any kind of data and used as a pointer to that data. For example, the user may wish to send the captured image to another user with a similar communication device. The captured image may have further information associated therewith such as the sender's own IP address or communication device address thereby enabling the sender to disseminate their own or other users' address information and associated captured images.

When the user has entered a photo into an address record, the photo is automatically entered into an onscreen address book. The onscreen address book preferably comprises a further display 13 showing a plurality of captured images associated with stored address records in an elongate strip. The onscreen address book may either be a window in the main screen or can be included in a dedicated separate screen. The address book is only present on screen when in use but the window specified therefor may be used in relation to facilitate other functions.

Preferably, the captured images are displayed as a strip of individual images but the images can be displayed individually. For example, seven captured images may be displayed as a line of photos, one right next to the other. Then, when a user enters more than seven photos into the onscreen address book, the address book field becomes scrollable. To scroll through the onscreen address book, a user will use a left arrow, located on the left side of the onscreen address book, to scroll left and a right arrow, located on the right side of the onscreen address book, to scroll right. When the onscreen address book is scrollable, the photo symbols will move to the left or right, depending on which arrow is being pressed, and will disappear off the screen when they reach the location of the scrolling arrow that is being pressed. When a photo symbol disappears another photo symbol appears at the other end of the onscreen address book. The user is able to access these images in a number of ways: by clicking on the screen with the stylus or their finger in order to bring up the next photograph or, a set number of photos may appear on screen at one time.

Once the user has found the required captured image which represents the person, group of people, or website with whom the user wishes to communicate, the user can click on that image to select it. When a photo is selected, the user can click on a further button to perform a required function in relation to that person, group, or website. For example, the user can select a captured image to create a communication link with the user associated with that captured image. Alternatively, the user can send the user associated with that captured image a message that has previously been written using the communication device or access a website associated with that captured image.

If a user selects a captured image it becomes highlighted (i.e. the colouring of the photo changes significantly). Then, when the user executes a required function, the communication device will retrieve the required address information from the address record related to the highlighted captured image. For example, if a user selects a function that allows them to compose a message to another user whose captured image has been highlighted in the onscreen address book, the user will write the message and then, when the user presses the send button, the communication device will locate the address record related to the highlighted captured image and retrieve the communication device address number or IP address stored in the associated address record. The communication device will then send the message to the communication device of the user identified by the highlighted captured image.

The above embodiment of the present invention associates the symbol or captured image, preferably a user's face, with the communication device address number or IP address of that user or group of users. In another embodiment, instead of captured images being associated with one or more specified address records, text based links are used. No photographs would be used in this example.

Another example of the present invention provides for pictorial symbols to be downloaded from a website onto the communication device. Integral to the symbol is an associated communicator linking code. There are two types of linking code: one which will link any device with the symbol present in its address book/database to a website, the other which will link any device with the symbol present in its address book/database to one or more communication devices which have already downloaded, or have by some other means, the same symbol and thence the associated communicator linking code present in their address book/database.

The user who pays for and downloads the symbol can duplicate the symbol on the screen of their own device and send the duplicate symbol with associated communicator linking code and other data to other people directly by inter-communication device communication or via a server. The group is thus defined by the symbol and will have access to the same person/group of people/Internet site where the same symbol and associated communicator linking code are resident.

To use these pictorial group related symbols, a user would purchase and download a symbol from a website and then use the address book integral to their communication device to create a new address record to select names and associated details from the address book and associate those with the symbol.

One function of the communication device address book is to create and organise groups associated with specified symbols or captured images. In operation, the user attaches a name for the group to be associated with the symbol and then adds members from the address book to the group and enters other address related information for the group such as a web site address specifically for that group. In one embodiment, the group website address is already associated with the symbol when bought and downloaded. Once the user has entered all the group members and the web site address related to the new group symbol, then the user must confirm the creation of the new group. The confirmation comprises the communication device sending the symbol with the attached communicator linking code, the group member identities and any other group member data and the related website address to a server where the group data related to the symbol is to be stored. The server requests each group member to collect a message. When the group member retrieves their message from the server, they will download the symbol which makes them part of the group associated with the symbol. Along with the symbol, they will download the appropriate data associated with the symbol. The group members communication device addresses are also transferred but are invisible to the devices that did not originate them. In this way, individual group members do not communicate with each other unless they do so through the use of the group symbol. Each member can therefore control if another member can continue to contact them: they can prevent communication by removing the group symbol from their device.

The adding of new members and creation of new groups could also take place on a web site. The user that creates the group could purchase the symbol on the web site and enter the communication addresses of the group members and other data and press a send button to send the symbol and its associated web address information to the other group members. Alternatively, the symbol could allow users access to existing groups on the Internet. For example, users could purchase and download symbols to join chat rooms, professional societies, or clubs on the Internet. These group interactions could either take place on the Internet or new group information could be downloaded to the user's communication device when the user requests it. Group members that have been added to a new group will receive the symbol as an incoming message on their communication device screen. They will then transfer the symbol and its related address record into their address book in order to be able to access and contribute information to the new group.

The symbols associated with groups can be compiled in a separate address book which would work similarly to the scrolling photograph address book. When the user has entered a group symbol into an address record the symbol is automatically entered into an onscreen address book. The onscreen address book may either be on screen at all times, or alternatively the address book is only present on screen when its use may be required in relation to other functions that are present on screen. The onscreen address book may be located anywhere on the screen. Access to the onscreen group symbols would be effected in the same manner as the above described access to the address book of captured images.

Another aspect of the present invention provides, in one embodiment, a network consisting of at least one server and a plurality of communication devices substantially as described above. The database is resident on the server and is accessible by the various communication devices. Each communication device has an individual identification number which serves as a means for identifying the user of that communication device. Each communication device incorporates a camera for capturing images, an address book or database substantially as described above, a display and a stylus or some other means of creating text such as a keypad.

The database resident on the server carries a plurality of records. Each record comprises at least the following information: a captured image of an item: the identification number of the user owning or having access to the item: and a category identifier to identify which category of item the item falls within.

Each communication device also includes a group database. Each record on the group database specifies a group member identified by a captured image of the group member, the group members communication device identification number and contact information for the group member. In one embodiment, the group database comprises the address book or address database described above. In another embodiment of the present invention, the group database is defined by those group members having a particular plug or symbol attached to their communication device.

The preferred use of the database resident on the server in combination with the communication devices is to allow users of the communication devices to arrange and agree to swap items within their group in response to requests from other group members.

In operation, the user captures an image of an item which they wish to share or make available to other members of their group using the camera incorporated in the communication device. As an option, the user can associate a category with the item. This information, together with the user's identification number is transmitted to the database resident on the server and stored thereon. If category information has been included in the record, then the record is stored in a particular category. Examples of categories might be, for the sharing of clothes: tops; dresses or skirts; shoes, jumpers and accessories.

Access to records on the server database by individuals having communication devices is limited to those records created by individuals belonging to the group database on a particular communication device. Thus, the individual using a communication device would have access to all the records of items created by group members.

In use, the communication device has a display 11 which displays records from the database resident on the server and allows a user to browse those items which have been placed on the database by the individuals in that communication device's group database. The user selects an item which they wish to borrow. The act of selecting the item causes the communication device to identify the individual associated with that item on the record on the database resident on the server. This identification is preferably by highlighting a captured image of the individual and displaying the same on the communication device's display 11 or on a separate display 13 of the communication device. The user can then either with their stylus or keypad write a message or note over the selected item and then send the message or note to the individual associated with the selected item. The message or note is automatically delivered to the individual who has been identified as being associated with the item by the identification number of their communication device. There may be further communication between the user and the identified individual concerning the item to be borrowed and the arrangements for borrowing the item.

In another embodiment of the present invention, a downloaded symbol may be associated with a service provider or telecommunications operator such that when the symbol is downloaded and resident on an individual's communication device, the cost of the individual's calls, transactions or other activities are subsidised. It may be that only those calls associated with contacting the party issuing the symbol are subsidised.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A communication device operable to communicate with other communication devices in a network, one or more of the communication devices having means to receive identification data to authorise or identify a user as part of a closed community of users within the network, the closed community being defined by those communication devices within the network which have matching identification data.

2. A communication device according to claim 1, wherein the identification data is stored in a physical element for attachment to or incorporation in a communication device.

3. A communication device according to claim 2, wherein the physical element is a plug which is insertable in a socket of a communication device.

4. A communication device according to any one of claims 2 to 4, wherein the physical element is provided with a graphical representation indicative of a closed community defined by the identification data.

5. A communication device according to any preceding claim, wherein the identification data comprises an authorisation or identification code, a password, a telephone number, an e-mail address, an IP address, or a URL.

6. A communication device according to claim 1, wherein the identification data is graphically represented in an online environment and is obtainable therefrom for distribution to users to establish a closed community for communication between users provided with the same identification data.

7. A communication device according to any preceding claim, wherein matching means are provided to enable communication between communication devices if identification data held by one communication device matches identification data held by another communication device and to prevent communication between communication devices if identification data held by one communication device does not match identification data held by another communication device.

8. A communication device according to any preceding claim, wherein the communication device is a mobile communication device.

9. A communication device according to any preceding claim, wherein the communication device is a personal computer.

10. A communication device according to any preceding claim, wherein the communication device further comprises: a camera operable to capture digital images and at least one display screen to display the resultant images.

11. A communication device according to any preceding claim, wherein the communication device further comprises a memory incorporating an address database, the address database containing a plurality of address records comprising contact information.

12. A communication device according to claim 12 when dependent upon claim 11, wherein a captured image is associated with an address record in the address database.

13. A communication device operable to communicate with other communication devices in a network, the communication device comprising: a camera operable to capture digital images; at least one display screen to display the resultant images; a memory incorporating an address database, the address database containing a plurality of address records comprising contact information, wherein a captured image is associated with an address record in the address database.

14. A communication device operable to communicate with other communication devices in a network, the communication device comprising: mobile communication means having a network connection; at least one display screen to display the symbols; a memory incorporating an address database, the address database containing a plurality of address records comprising contact information, wherein a symbol downloaded from the network is associated with an address record in the address database.

15. A communication device according to claim 15, wherein each symbol has an associated communicator linking code operable to link the device having the communicator linking code resident therein with one or more other devices also having the communicator linking code resident therein.

16. A communication device according to any one of claims 14, 15 or 16, wherein the captured images or symbols are displayed and a selector is provided to select one of the displayed captured images or symbols to enable communication with the or each contact identified by the address record associated with a selected captured image or symbol.

17. A communication device according to claim 17, wherein a further display is provided and the captured images or symbols are displayed thereon.

18. A communication device according to any one of claims 14 to 18, wherein a database is provided on a remote server comprising a transaction database of items which are intended to be bought, collected, hired, swapped, exchanged or otherwise transacted.

19. A communication device according to claim 18, wherein each record held on the transaction database is associated with an item and includes an image of the item captured using the camera of the communication device.

20. A network of communication devices according to any preceding claim.

21. A method of establishing a closed community within a communications network comprising the steps of:
providing a network of communication devices operable to communicate with one another;
distributing identification data to selected ones of communication devices within the network;
enabling communication between communication devices having matching identification data; and
preventing communication between communication devices not having matching identification data.

22. A method according to claim 22, wherein a server in the network is advised of a new closed community and identification data is distributed to the members of the closed community by the server.

23. A method according to claim 23, wherein identification data is distributed to selected ones of communication devices within the network by the following steps: one of the communication devices sends to the server the identification data and details of the intended members of the closed community; the server stores the identification data and details of the intended members of the closed community; and each intended member of the closed community downloads the identification data from the server.

24. A method according to claim 24, wherein the server requests each intended member of the closed community to collect a message and, upon collection of said message, the intended member of the closed community downloads the identification code to enable communication between communication devices having matching identification data.

25. A method according to any one of claims 22 to 23, wherein communication between communication devices having matching identification data takes place via a network node specified by the identification data.

26. A method according to claim 26, wherein the network node is a website, forum or chat site.

27. A method of establishing communication between communication devices, at least one communication device being operable to communicate with other communication devices in a network, that communication device comprising: a camera operable to capture digital images; at least one display screen to display the resultant images; a memory incorporating an address database, the address database containing a plurality of address records comprising contact information, wherein the or each captured image is associated with an address record in the address database, the method comprising the steps of: selecting one of the plurality of captured images; and initiating communication with the address associated with the selected captured image.

28. A communication device according to any one of claims 2 to 4, wherein the physical element incorporates a credit of a monetary value which may be debited to cover the cost of communication or the cost of conducting a transaction.

29. A network consisting of at least one server having a database resident thereon and accessible by a plurality of mobile communication devices, each communication device having: a unique identifier; a camera for capturing images; a contact database; and a display, wherein the database resident on the server carries a plurality of records, each record comprising at least the following information: a captured image of an item; and the unique identifier of a communication device associated with the item.

30. A network according to claim 29, wherein each record on the database resident on the server also includes a category identifier to identify which category of item the item falls within.

31. A network according to claim 29 or 30, wherein each communication device also includes a group database comprising a plurality of records each of which specifies a group member identified by a captured image of the group member and the unique identifier of that group member's communication device.

32. A network according to claim 31, wherein the group members are defined by those group members having a communication device with identification data stored in a physical element for attachment to or incorporation in a communication device.

33. A network according to claim 31, wherein the group members are defined by those group members having a communication device with identification data obtained from an online environment for distribution to users to establish a closed community for communication between users provided with the same identification data.

34. A network according to any one of claims 31 to 33, wherein a communication device has access to only those records on the database resident on the server which are associated with a group member included in the group database of that communication device.

35. A communication device for use in a network consisting of at least one server having a database resident thereon and accessible by a plurality of mobile communication devices, the communication device comprising: a unique identifier; a camera for capturing images; a display; and a group database comprising a plurality of records each of which includes the identification of a group member by a captured image of the group member and a unique identifier of that group member's communication device, wherein the database resident on the server carries a plurality of records, each record comprising at least the following information: a captured image of an item; and the unique identifier of a communication device associated with the item, the communication device having access to only those records on the database resident on the server which are associated with a group member included in the group database of that communication device.

36. A method of establishing and accessing a remote database comprising the steps of:
providing a mobile communication device having: a unique identifier, a camera for capturing images; a display; and a group database comprising a plurality of records identifying group members;
providing a server having a database resident thereon storing a plurality of records;
capturing an image of an item;
sending the captured image and the unique identifier to the server for inclusion on the server database as a new record; and
allowing access by a communication device to records on the server database.

37. A method according to claim 36, wherein a communication device has access to only those records on the server database which have been placed on the database by group members held as records on the group database of that communication device.

38. A method according to claim 37 or 38 comprising the further steps of:
a communication device selecting an item;
identifying the communication device associated with that item on the server database by reference to the unique identifier; and
facilitating communication between the communication device associated with the selected item and the communication device selecting the item.
